(19) United States
(12) Patent Application Publication
(10) Pub. No.: US 2013/0202268 A1
(43) Pub. Date: Aug. 8, 2013

(54) Blu-ray karaoke player

(71) Applicant: David Su, City of Industry, CA (US)

(72) Inventor: David Su, City of Industry, CA (US)

(21) Appl. No.: 13/385,131

(22) Filed: Feb. 3, 2012

(51) Int. Cl. H04N 5/775

(52) U.S. Cl. 386/230; 386/E05.07

(57) ABSTRACT

A blu-ray karaoke player includes a main housing and a central processing unit. The main housing has a vocal signal inlet for connecting to a microphone to obtain a vocal voice signal from a user, and a karaoke signal outlet for connecting to a display device and a speaker. The blu-ray player is supported in the main housing, and is adapted for reading a blu-ray disc for obtaining audio data and video data therefrom. The central processing unit is configured to decode the audio data and the video data obtained from the blu-ray disc, and process the vocal voice signal obtained from the microphone, and to output, through the karaoke signal outlet, the audio data, the vocal voice signal, and the video data to the display device and the speaker for allowing the user to perform karaoke activity through playing the blu-ray disc.

### BACKGROUND OF THE PRESENT INVENTION

1. Field of Invention

The present invention to karaoke, and more particularly to a karaoke player which is capable of playing a blu-ray disc so as to obtain video and audio data for allowing a player to perform karaoke activity.

2. Description of Related Arts

A conventional karaoke system usually comprises a DVD karaoke player, a display device electrically connected to the DVD karaoke player, and a speaker also connected to the DVD karaoke player, wherein the DVD karaoke player is adapted for playing a DVD disc which contains video data, audio data and lyrics data so that the video, audio and lyrics data is outputted to the display device and the speaker. Moreover, the conventional karaoke system further comprises a microphone electrically connected to the DVD karaoke player for receiving the user's vocal voice. The user's voice is then processed by the DVD karaoke player and is delivered to the speaker.

A major disadvantage of this kind of conventional karaoke systems is that almost all of these systems can only support DVD format, and none of them can support Blu-ray format. Since the size of televisions, particularly LED televisions, is ever-increasing, traditional DVD format is not sufficient to accommodate the need of enjoying karaoke through the use of a television having a larger screen size (such as a 56 inch LED television).

One of the difficulties for having a karaoke with Blu-ray format is that the Blu-ray format is difficult to decode and mix with lyrics. As a result, it is rather difficult to produce a high-definition (HD) video quality for karaoke activity.

### SUMMARY OF THE PRESENT INVENTION

The invention is advantageous in that it provides a karaoke player and system which are capable of playing a blu-ray disc so as to obtain video and audio data for allowing a player to perform karaoke activity. In other words, the provides a karaoke player and system of the present invention are capable of mixing digital and analog signal for facilitating karaoke activity.

Another advantage of the invention is to provide a karaoke player and system which are capable of playing a blu-ray disc, wherein the karaoke system is capable of producing high-definition video quality on a display device while the karaoke activity is being performed.

Another advantage of the invention is to provide a karaoke player and system which are capable of playing a blu-ray disc, wherein the karaoke player and system are also compatible with many other audio and video formats, such as MP3, WAV, WMA, MPEG-1, etc.

Another advantage of the invention is to provide a karaoke player and system which are capable of accessing to interne so as to allow online streaming or acquiring of karaoke content.

Additional advantages and features of the invention will become apparent from the description which follows, and may be realized by means of the instrumentalities and combinations particular point out in the appended claims.

According to the present invention, the foregoing and other objects and advantages are attained by providing a blu-ray karaoke player, comprising:

a main housing having a vocal signal inlet for connecting to a microphone to obtain a vocal voice signal from a user, and a karaoke signal outlet for connecting to a display device and a speaker;

a blu-ray player supported in the main housing, wherein the blu-ray player is adapted for reading a blu-ray disc for obtaining audio data and video data therefrom;

a central processing unit supported in the main housing and electrically connected to the blu-ray player, wherein the central processing unit is configured to decode the audio data and the video data obtained from the blu-ray disc, and process the vocal voice signal obtained from the microphone, wherein the central processing unit is also configured to output, through the karaoke signal outlet, the audio data, the vocal voice signal, and the video data to the display device and the speaker for allowing the user to perform karaoke activity through playing the blu-ray disc.

Still further objects and advantages will become apparent from a consideration of the ensuing description and drawings.

These and other objectives, features, and advantages of the present invention will become apparent from the following detailed description, the accompanying drawings, and the appended claims.

### BRIEF DESCRIPTION OF THE DRAWINGS

FIG. 1 is a front perspective view of a blu-ray karaoke player according to a preferred embodiment of the present invention.

FIG. 2 is a rear view of a blu-ray karaoke player according to a preferred embodiment of the present invention.

FIG. 3 is an exploded perspective view of a blu-ray karaoke player according to a preferred embodiment of the present invention.

FIG. 4 is a schematic diagram of a blu-ray karaoke system according to a preferred embodiment of the present invention.

### DETAILED DESCRIPTION OF THE PREFERRED EMBODIMENT

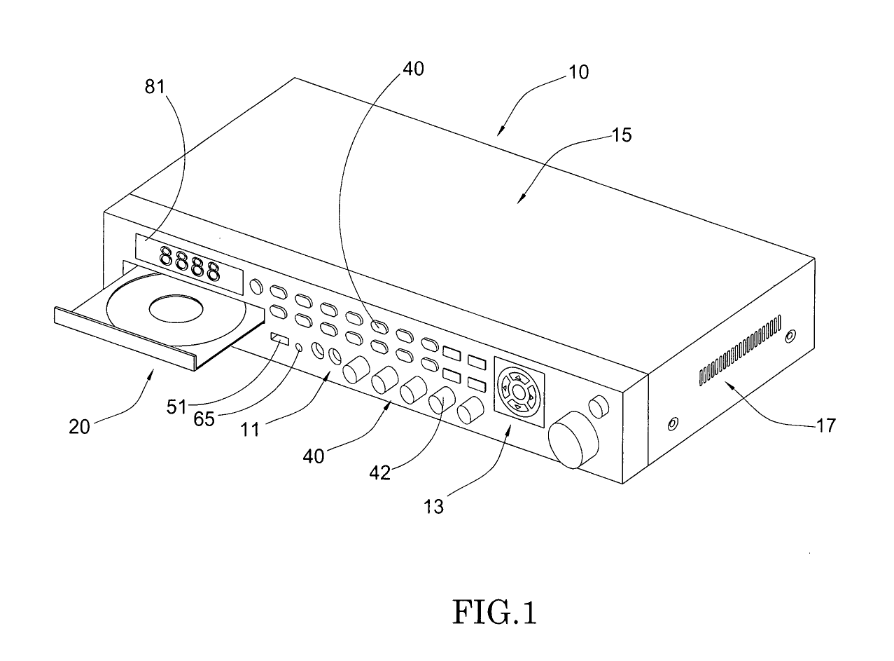

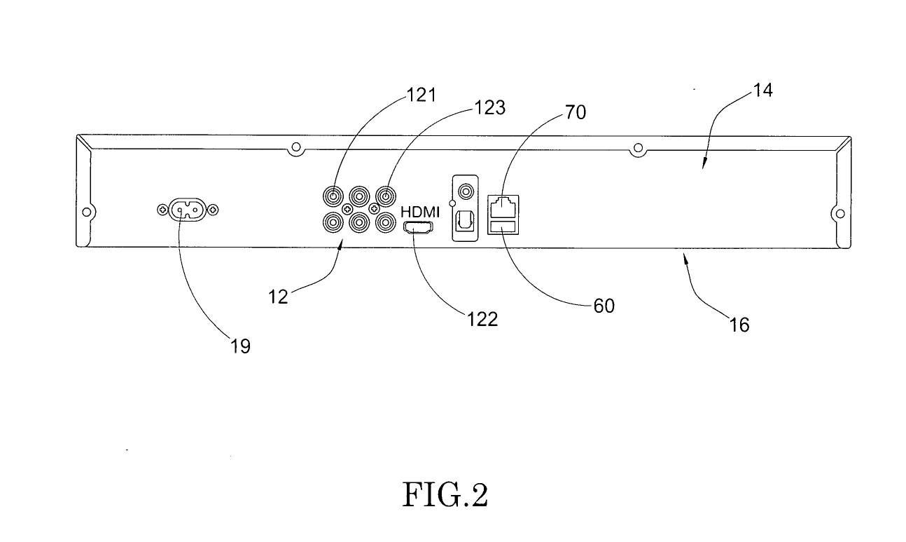

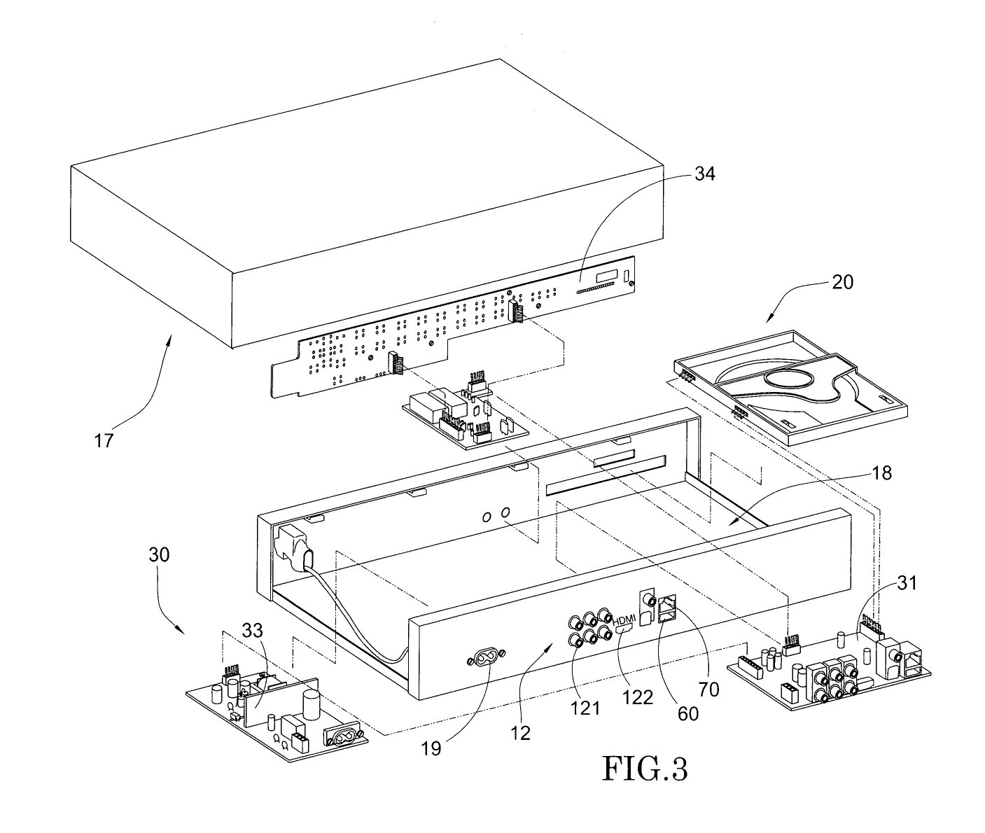

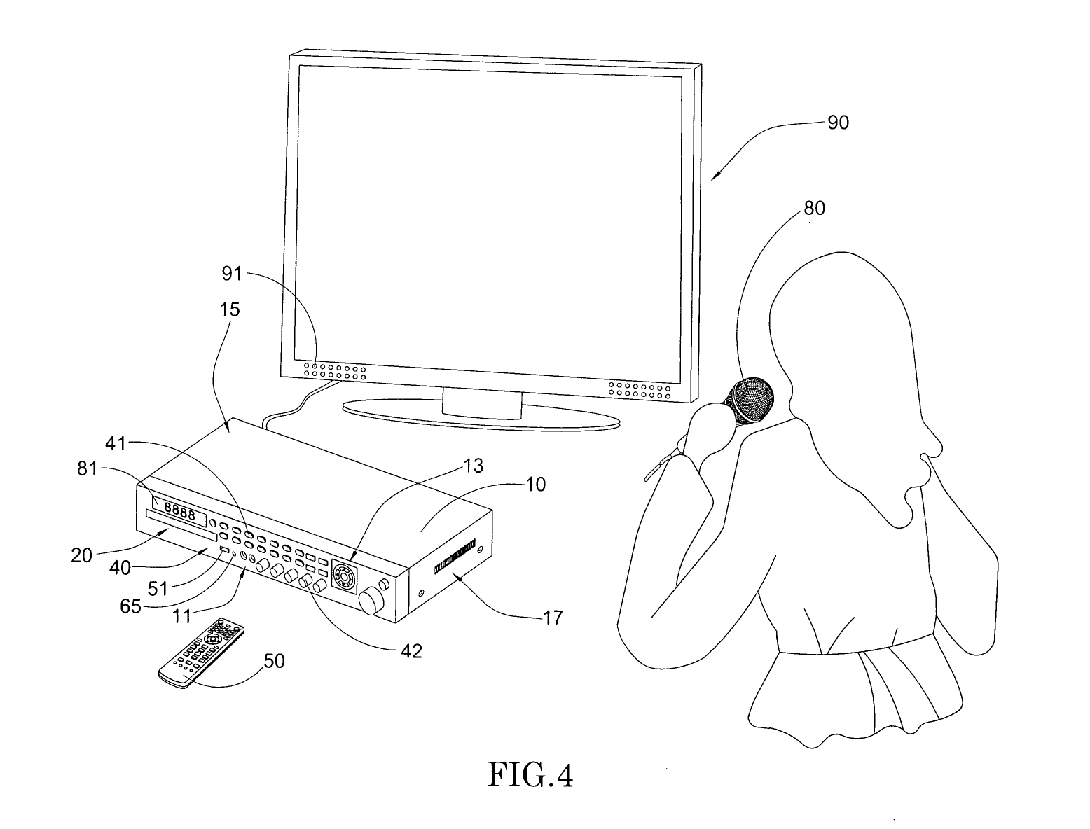

Referring to FIG. 1 to FIG. 4 of the drawings, a blu-ray karaoke player and a system according to a preferred embodiment of the present invention is illustrated. The blu-ray karaoke player comprises a main housing 10, a blu-ray player 20, and a central processing unit 30.

The main housing 10 has a vocal signal inlet 11 for connecting to a microphone 80 to obtain a vocal voice signal from a user, and a karaoke signal output 12 for connecting to a display device 90 and a speaker 91.

The blu-ray player 20 is supported in the main housing 10, wherein the blu-ray player 20 is adapted for reading a blu-ray disc for obtaining audio data and video data therefrom.

The central processing unit 30 is supported in the main housing 10 and electrically connected to the blu-ray player 20, wherein the central processing unit 30 is configured to decode the audio data and the video data obtained from the blu-ray disc, and process the vocal voice signal obtained from the microphone 80, wherein the central processing unit 30 is also configured to output, through the karaoke signal outlet 12, the audio data, the vocal voice signal, and the video data to the display device 90 and the speaker 91 for allowing the user to perform karaoke activity through playing the blu-ray disc.

According to the preferred embodiment of the present invention, the main housing 10 has a front surface 13, a rear surface 14, a top surface 15, a bottom surface 16, two sidewalls 17, and a receiving cavity 18 formed between the front surface 13, the rear surface 14, the top surface 15, the bottom surface 16 and the two sidewalls 17 for receiving the blu-ray player 20 and the central processing unit 30.

The blu-ray karaoke player further comprises a control panel 40 provided on the front surface 13 of the main housing 10 and is electrically connected to the central processing unit 30 for controlling an operation of the blu-ray karaoke player. The control panel 40 comprises a plurality of selection buttons 41 and a plurality of adjustment switches 42 provided on the front surface 13 of the main housing 10 for allowing a user to selectively control an operation of the blu-ray karaoke player. The selection buttons 41 and the adjustment switches 42 adapted for controlling such paying parameters as volume, key, track, bass, etc.

The blu-ray player 20 is arranged to read audio and video data from a blu-ray disc. It is important to mention that the blu-ray player 20 is also arranged to read data in different formats, such as BD-ROM, BD-R, BD-RE, DVD, VCD, CD-RW, MP3G, CD+Gs, and CDs etc. In other words, the blu-ray player 20 can read a wide variety of data discs so as to facilitate a widespread application of the present invention.

The karaoke signal output 12 comprises a plurality of components video outlets 121 provided on the rear surface 14 of the main housing 10, and a HDMI outlet 122 also provided on the rear surface 14 of the main housing 10, wherein each of the components video outlets 121 and the HDMI outlet 122 are electrically connected to the central processing unit 30. Video signals read from the blue-ray disc are processed by the central processing unit 30 and is outputted from one of the components video outlets 121 (for component video outputs) and the HDMI outlet 122 (for high definition video and audio output).

Moreover, the karaoke signal output 12 further comprises a plurality of components audio outlets 123 provided on the rear surface 14 of the main housing 10

The blu-ray karaoke player further comprises a remote controller 50 wirelessly connecting with the central processing unit 30 for allowing a user to remotely control an operation of the blu-ray karaoke player. Thus, the blu-ray karaoke player further comprises a wireless transceiver 51 provided on the main housing 10 for receiving the wireless signal from the remote controller 50.

The central processing unit 30 comprises a central processing circuitry 31 electrically connected to the blu-ray payer 20 in such a manner that the data read from the blu-ray player 20 is transferred to the central processing circuitry 31 for signal processing. Thus, the digital signal acquired from the blu-ray disc or other supported medium will be process in the central processing circuitry 31 and transformed into video and audio output signals. These signals are then transferred to the karaoke signal outlet 12 for outputting to the display device 90 and the speaker 91.

The central processing unit 30 further comprises an analog signal processing circuitry 32 supported in the receiving cavity 18 and is electrically connected to the central processing circuitry 31, wherein the analog signal processing circuitry 32 is arranged to receive vocal voice signal from the user and process it in such a manner that the audible voice of the user may be output through the karaoke signal outlet 12. The audible voice may then be delivered by the speaker 91.

Accordingly, the voice signal inlet 11 is provided on the front surface 13 of the main housing 10 and is in communication with the analog signal processing circuitry 32 so as to receive signal of the audible voice from the user when the microphone 80 is connected to the voice signal inlet 11. Note that the microphone 80 may be a wireless microphone in which case a wireless transceiver is connected to the voice signal inlet 11 for wirelessly receiving the voice signal from the wireless microphone 80. Of course, the microphone 80 can also be connected to the voice signal inlet 11 through a connection cable.

The central processing unit 30 further comprises a power transforming circuitry 33 provided in the receiving cavity 18 of the main housing and is electrically connected to the central processing circuitry 31 for providing electrical power to the central processing circuitry 31 and other components of the blu-ray karaoke player. Moreover, the main housing 10 further comprises a power inlet 19 provided on the rear surface 14 thereof, wherein the power inlet 19 is electrically connected to the power transforming circuitry 33 which is arranged to transform externally acquired AC power into DC power. The DC power is then transmitted to the central processing unit 30.

The blu-ray karaoke player further comprises at least one USB port 60 provided on the rear surface 14 of the main housing 10 for connecting to an external USB drive. The USB port 60 is electrically connected to the central processing circuitry 31 which is arranged to process the data acquired from the external USB drive. For example, the central processing circuitry 31 is capable of processing RMVB files for displaying video stored in this format on the display device 90. JPEG or other image files stored in the external USB drive can also be processed by the central processing circuitry 31 and displayed on the display device 90.

The blu-ray karaoke player further comprises at least one audio port 65 provided on the front surface 13 of the main housing 10 and is electrically connected to the central processing circuitry 31, wherein the audio port 65 is adapted for connecting to an external headphone and for delivering audio signal to the headphone. This allows a user to listen to audio materials played by the blu-ray karaoke player through the external headphone. This may also allow the user to practice singing by listening to his or her own voice.

The central processing unit 30 further comprises a control panel circuitry 34 mounted in the receiving cavity 18 of the main housing 10 and is electrically connected between the analog signal processing circuitry 32 and the control panel 40 for controlling it. The analog actuation (such as the turning of a volume adjustment switch 42) received by the control panel 40 is interpreted and processed by the control panel circuitry 34. The corresponding command is then transmitted to the central processing circuitry 31 through the analog signal processing circuitry 32. The central processing circuitry 31 is then arranged to execute the command corresponding to the actuation performed on the control panel 40.

The blu-ray karaoke player further comprises at least one LCD display 81 provided on the front surface 13 of the main housing 10 and is electrically connected to the central processing unit 30 for displaying a playing status of blu-ray karaoke player.

A blu-ray karaoke player further comprises an Ethernet port 70 provided on the rear surface 14 of the main housing 10 for connecting to an external internet or network cable. The Ethernet port 70 is electrically connected to the central processing circuitry 31 which is also arranged to process data relating to internet access. As a result, the blu-ray karaoke player of the present invention is capable of downloading or streaming karaoke video through internet.

From the forgoing description, it can be seen that the present invention also discloses a blu-ray karaoke system, comprising the blu-ray karaoke player, the microphone 80 connected to the blu-ray karaoke player, the display device 90 connected to the blu-ray karaoke player, the speaker also connected to the blu-ray karaoke player, wherein the blu-ray karaoke player is capable of playing blu-ray disc and a user is allowed to perform karaoke activity using the microphone 80.

One skilled in the art will understand that the embodiment of the present invention as shown in the drawings and described above is exemplary only and not intended to be limiting.

It will thus be seen that the objects of the present invention have been fully and effectively accomplished. It embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A blu-ray karaoke player, comprising:
a main housing having a vocal signal inlet for connecting to a microphone to obtain a vocal voice signal from a user, and a karaoke signal output for connecting to a display device and a speaker;
a blu-ray player supported in said main housing, wherein said blu-ray player is adapted for reading a blue-ray disc for obtaining audio data and video data therefrom; and
a central processing unit supported in said main housing and electrically connected to said blu-ray player, wherein said central processing unit is configured to decode said audio data and said video data obtained from said blu-ray disc, and process said vocal voice signal obtained from said microphone, wherein said central processing unit is also configured to output, through said karaoke signal outlet, said audio data, said vocal voice signal, and said video data to said display device and said speaker for allowing said user to perform karaoke activity through playing said blu-ray disc.

2. The blu-ray karaoke player, as recited in claim 1, wherein said central processing unit comprises a central processing circuitry electrically connected to said blue-ray payer in such a manner that said data read from said blu-ray player is transferred to said central processing circuitry for signal processing.

3. The blu-ray karaoke player, as recited in claim 2, wherein said central processing unit further comprises an analog signal processing circuitry supported in said receiving cavity and is electrically connected to said central processing circuitry, wherein said analog signal processing circuitry is arranged to receive vocal voice signal from said user and process it in such a manner that said audible voice of said user is outputted through said karaoke signal outlet.

4. The blu-ray karaoke player, as recited in claim 3, wherein said voice signal inlet is provided on said front surface of said main housing and is in communication with said analog signal processing circuitry so as to receive signal of said audible voice from said user when a microphone is connected to said voice signal inlet.

5. The blu-ray karaoke player, as recited in claim 4, wherein said central processing unit further comprises a power transforming circuitry provided in said receiving cavity of said main housing and is electrically connected to said central processing circuitry for providing electrical power to said central processing circuitry.

6. The blu-ray karaoke player, as recited in claim 5, wherein said main housing has a front surface, a rear surface, a top surface, a bottom surface, two sidewalls, and a receiving cavity formed between said front surface, said rear surface, said top surface, said bottom surface and said two sidewalls for receiving said blu-ray player and said central processing unit.

7. The blu-ray karaoke player, as recited in claim 2, further comprising a control panel provided on said front surface of said main housing and is electrically connected to said central processing unit for controlling an operation of said blu-ray karaoke player, wherein said control panel comprises a plurality of selection buttons and a plurality of adjustment switches provided on said front surface of said main housing for allowing a user to selectively control an operation of said blu-ray karaoke player.

8. The blu-ray karaoke player, as recited in claim 6, further comprising a control panel provided on said front surface of said main housing and is electrically connected to said central processing unit for controlling an operation of said blu-ray karaoke player, wherein said control panel comprises a plurality of selection buttons and a plurality of adjustment switches provided on said front surface of said main housing for allowing a user to selectively control an operation of said blu-ray karaoke player.

9. The blu-ray karaoke player, as recited in claim 6, wherein said karaoke signal output comprises a plurality of components video outlets provided on said rear surface of said main housing, and a HDMI outlet also provided on said rear surface of said main housing, wherein each of said components video outlets and said HDMI outlet are electrically connected to said central processing unit, wherein video signals read from said blu-ray disc are processed by said central processing unit and is outputted to one of said components video outlets and said HDMI outlet.

10. The blu-ray karaoke player, as recited in claim 8, wherein said karaoke signal output comprises a plurality of components video outlets provided on said rear surface of said main housing, and a HDMI outlet also provided on said rear surface of said main housing, wherein each of said components video outlets and said HDMI outlet are electrically connected to said central processing unit, wherein video signals read from said blu-ray disc are processed by said central processing unit and is outputted to one of said components video outlets and said HDMI outlet.

11. The blu-ray karaoke player, as recited in claim 9, wherein said karaoke signal output further comprises a plurality of components audio outlets provided on said rear surface of said main housing.

12. The blu-ray karaoke player, as recited in claim 10, wherein said karaoke signal output further comprises a plurality of components audio outlets provided on said rear surface of said main housing.

13. The blu-ray karaoke player, as recited in claim 10, further comprising a remote controller wirelessly connecting with said central processing unit for allowing a user to remotely control an operation of said blu-ray karaoke player, and a wireless transceiver provided on said main housing for receiving said wireless signal from said remote controller.

14. The blu-ray karaoke player, as recited in claim 12, further comprising a remote controller wirelessly connecting with said central processing unit for allowing a user to remotely control an operation of said blu-ray karaoke player, and a wireless transceiver provided on said main housing for receiving said wireless signal from said remote controller.

15. The blu-ray karaoke player, as recited in claim 10, further comprising at least one USB port provided on said rear surface of said main housing for connecting to an external USB drive.

16. The blu-ray karaoke player, as recited in claim 14, further comprising at least one USB port provided on said rear surface of said main housing for connecting to an external USB drive.

17. The blu-ray karaoke player, as recited in claim 14, wherein said central processing unit further comprises a control panel circuitry mounted in said receiving cavity of said main housing and is electrically connected between said analog signal processing circuitry and said control panel for controlling said controlling panel in such a manner that an analog actuation received by said control panel is interpreted and processed by said control panel circuitry, wherein said actuation is transmitted to said central processing circuitry for execution.

18. The blu-ray karaoke player, as recited in claim 16, wherein said central processing unit further comprises a control panel circuitry mounted in said receiving cavity of said main housing and is electrically connected between said analog signal processing circuitry and said control panel for controlling said controlling panel in such a manner that an analog actuation received by said control panel is interpreted and processed by said control panel circuitry, wherein said actuation is transmitted to said central processing circuitry for execution.

19. The blu-ray karaoke player, as recited in claim 18, further comprising an Ethernet port provided on said rear surface of said main housing for connecting to an external internet device.

20. The blu-ray karaoke player, as recited in claim 19, further comprising an audio port provided on said front surface of said main housing and is electrically connected said central processing unit for delivering audio signal to an external headphone.
